(19) United States
(12) Patent Application Publication
(10) Pub. No.: US 2003/0163917 A1
(43) Pub. Date: Sep. 4, 2003

(54) Wire harness guided assembly and method for use thereof

(76) Inventors: Patrick J. Davidshofer, Upton, MA (US); Timothy W. Alibozek, Upton, MA (US)

Correspondence Address: Patrick J. Davidshofer, 6 Pine Street, Upton, MA, 01568, US

(21) Appl. No.: 10/379,194

(22) Filed: Mar. 4, 2003

Related U.S. Application Data
(60) Provisional application No. 60/361,536, filed on Mar. 4, 2002.

(51) Int. Cl. H01R 43/00; B23P 19/00

(52) U.S. Cl. 29/854; 29/868; 29/748

(57) ABSTRACT

An apparatus and method for electronically sequencing and guiding wire path and wire connection information during the manufacturing process of wire harnesses. The user of the apparatus and method assembles a wire harness on a assembly board which has an electronic display device contained therein which has the ability to display path and text information for each specific wire contained within a specific wire harness design. The assembly board is connected to a computer that sequences and sends the information for each wire to the display. The process entails receiving assembly control data from a computer that simultaneously displays information about a specific wire on the computer screen and on the display device in the form board. The images on the display device are the life size and path of where a wire should be placed within the wire harness. Additional information is also displayed for each wire that indicates a face view of the connector that each wire end point is connected to, the connector slot each wire will be inserted into, specific handling and testing instructions or any other pertinent assembly instructions. The computer information is generated by a computer-aided-design program (CAD) or graphical software package.

### CROSS-REFERENCE TO RELATED APPLICATIONS

This application claims priority to U.S. S No. 60/361,536, filed Mar. 4, 2002, which is hereby incorporated by reference in its entirety.

### BACKGROUND OF THE INVENTION

1. Technical Field

The present invention relates generally to the field of electronics manufacturing and more specifically to the automation of the assembly of wire harnesses of varying configurations.

2. Background

A wire harness is a collection of bundled wires tied together with their endpoints affixed to connector devices. Wire harnesses are manufactured as separate entities of a complete electromechanical system such as an automobile, an airplane or medical equipment. Most electromechanical systems contain many individual wire harnesses. Wire harnesses can contain two to thousands of wires, with single to multiple terminations. FIG. 1A displays a typical small wire harness with about 50 wires. This is a rather simple wire harness and is shown for illustrative purposes only. It is important to recognize that the length of the individual wires, as well as the number of branches and the connectors which terminate each branch, vary with the complexity and location of the electronic equipment and modular components which typically make up a given electronic system. Each wire harness is unique in design to the given system and machine for which the harness is designed.

The present construction process of an individual wire harness involves a step whereby a human operator places, or forms, each individual wire of the harness one at a time from a starting point through a specific path to an ending point. (See FIG. 1B) This step is usually conducted on an assembly table that is traditionally comprised of a large slab of plywood with nails or pegs protruding in order to help form and guide the wires. This assembly table is commonly referred to as the form board. The current manufacturing process requires one form board for each unique wire harness configuration that is being assembled. The design, construction and storage of these unique form boards is costly and a very resource intensive part of the wire harness assembly process as unique configurations exist for all current and previously manufactured wire harnesses.

The assembly of the wire harness on the form board is performed manually using wires, connectors and sleeves that are routinely pre-processed for integration into the final assembly. FIGS. 1C and 1D display examples of the form boards that wire harnesses are built on. After a wire has been placed, each wire's end point is then inserted into a specific slot within a specific connector device. In order to determine which specific path each wire must follow, an operator typically uses a life size drawing of the wire harness, affixed to the form board that displays all of the paths for every wire. The operator consults a separate document or a chart located on the drawing to determine a specific wire's start and end points (all start and end points of the harness drawing are labeled with unique designations). The operator also consults a separate document or a chart on the drawing to determine which connector and connector slot each wire's end point will enter.

While this process of using paper drawings and boards of nails has been proven within the wire harness production process for over 50 years, it is identified as being one of the prime bottlenecks in the overall wire harness manufacturing process. Other steps in the overall process take advantage of more modern techniques such as utilizing automatic wire cutting and sleeving machines and the use of computer software programs to generate quotes and manage inventory. The present wire placement and insertion process is very susceptible to delays and human error because of the constant vacillation between the consultation of detailed charts and documents for correct path and connection information and performing the operation—for each and every wire. The two dimensional (“2D”) drawing used in manufacturing contains every end point and route path for all of the wires of the harness, regardless of the complexity of the harness, and therefore provides a difficult visual mapping for an operator to identify and trace the two specific end points and associated routing for each wire. The identification of the next wire to be assembled in the assembly sequence is time consuming and inhibits productivity. The complexity of a wire assembly in relation to the 2D drawing can cause the operator to easily misroute or misconnect a wire to a connector, or in extreme cases allow the operator to skip a wire altogether. Experienced operators attempt to memorize the sequence and locations of the wires in a wire assembly as opposed to consulting the charts on a routine basis in order to assemble more efficiently. An operator working on a new or different assembly has a significant learning curve before attaining the experience and ability necessary to attain this level of production efficiency.

Wire harness manufacturers are continually faced with changes made to the design or components of a wire harness assembly, such as re-routed wires to new end points. These changes are difficult to integrate into the current form board and require significant time and effort to effect the transition to the new or revised design.

The assembly of wire harnesses is typically labor intensive in an environment where quality requirements have become increasingly stringent. As a result, harness manufacturers have looked to automate assembly techniques as a way to increase productivity and reduce the incidence of manufacturing defects. There have been many attempts to automate various aspects of the process described above through time. None of these attempts consider the entire wire harness fabrication process as one that an assembler can be guided and controlled through all phases of production, from form board creation to final testing of finished product, or provide the ability to significantly improve manufacturing throughput and address concerns of quality, training and automated process review.

Historically, wire harness manufacturers have been cautious and relatively slow to migrate to automated processing as an answer to the difficult task of complying with rigorous quality standards. A majority of this reluctance can be attributable to the high number of process variables (i.e., wire gauge, length, color, marking, terminal and connector type, etc.), and the flexible/unpredictable nature of wire itself, i.e. a wire can bend and/or twist such that its length dimension changes. These process variables, along with increased volume demand and design features for wire harnesses, make the automation of wire harness assembly a difficult challenge, but one with many opportunities to address current manufacturing shortcomings.

One of the reasons for the slow migration to automation of the assembly of harness configurations is due to the focus on robotics as the primary means to improve efficiency and quality. This focus has led to many failures, as advancements in robotics still cannot manage all the production variables noted above. The flexibility necessary to adapt to the multitude of process, design and demand variables has not readily been realized. Robotics is simply not capable of overcoming these challenges in an efficient manner, as a robot is unable to replicate the decision-making and dexterity of a person who is assembling a wire harness. These shortcomings in prior attempts magnify the need for an automated control apparatus to be integrated and harmonized with peripheral manual assembly operations performed by a human. The invention submitted represents the optimal combination of machine and labor to meet the challenges of wire harness assembly.

It is an object of the present invention to provide a reusable assembly table and method for electronically designing and guiding the manufacturing process of wire harnesses that eliminates errors, decreases manufacturing related costs and improves productivity.

### BRIEF SUMMARY OF THE INVENTION

This invention pertains in part to an assembly table and method for electronically sequencing and guiding wire path and wire connection information during the manufacturing process of wire harnesses. It is an object of the present invention to provide a wire harness manufacturing method that allows any person with no knowledge or experience of the wire harness manufacturing process to carry out detailed and complicated production of wire harnesses effectively.

A first aspect of the present invention is an apparatus for guiding, controlling and monitoring assembly of a wire harness comprised of a display device operably linked to an assembly table. One embodiment of this aspect is a display device capable of displaying text and images generated by a software program. A second embodiment of this aspect has software capable of receiving instructions via voice commands, wired controls or wireless controls. A third embodiment of this aspect is one or more input/output interfaces operably liked to the apparatus. A final embodiment of this aspect is a display device that is a computer.

A second aspect of the present invention is a configurable wire harness assembly table for the production of a wire harness comprised of a display device which is capable of presenting text and images through receiving information from a computer, a translucent work surface capable of receiving assembly pins and a plurality of removable assembly pins. One embodiment of this aspect of the invention is a wire harness assembly table where the translucent work surface comprises a plurality of holes capable of receiving removable assembly pins. A second embodiment of this aspect of the invention is a wire harness assembly table where the assembly table is adjustable along one or more axes. A further embodiment of the invention is a wire harness assembly table comprises one or more adapter means operably connecting two or more wire harness assembly tables. Another embodiment of this aspect of the invention is where the translucent assembly surface has been treated with a scratch-proofing compound. A still further embodiment of this aspect is a wire harness assembly table comprising one or more receptacles. A final embodiment of this aspect of the invention is a wire harness assembly table where the display device is a light emitting diode (LED) unit, a organic light emitting diode (OLED), a liquid crystal display (LCD) unit, a hologram, a cathode ray tube (CRT) or a computer.

A further aspect of this invention is a configurable wire harness assembly table for the production of a wire harness comprising a display device capable of presenting text and images from a computer in order to display wire path and connection information for each individual wire in a wire harness where the display device further comprises a translucent work surface and one or more removable assembly pins. One embodiment of this further aspect of the invention is a wire harness assembly table where the translucent assembly surface is a composite material.

Still another aspect of the present invention is a method for electronically assembling a wire harness comprising the steps of a) the display of predetermined images and text on a display device capable of generating images from a software program where the image represents a wire harness design, b) the insertion of one or more pins into an assembly table operably connected to a display device where the pin placement is controlled by the software, c) the placing of a wire on the assembly table with the wire placement being controlled the software, d) the termination of wires into cavities of connector housings where cavity location is controlled by the software, e) the completion of assembly instructions specific to wires placed where the assembly instructions are controlled by the software, f) the repeating of steps c), d) and e) one or more times until all wires in the wire harness design have been placed, g) the affixing of tie wraps to groups of wires where the location of the tie wraps is controlled by the software, h) the testing of the wire terminations and wire harness circuits where the testing comprises visual and electronic inspection such that a wire harness is assembled. One embodiment of this aspect of the invention is where the software accumulates and presents management efficiency statistics. A second embodiment of this aspect of the invention is where the software and testing provides conflict and error notification to the assembler for resolution. A third embodiment of this aspect of the invention is where the software sizes and formats the wire harness designs to the assembly table size.

### BRIEF DESCRIPTION OF THE DRAWINGS

FIG. 1A is an example of a small wire harness.

FIG. 1B is an example of an assembler creating a wire harness on a form board.

FIG. 1C is a face view of popular form board configuration.

FIG. 1D is a second face view of another version of popular form board configuration.

FIG. 2A is a schematic illustration of a complete wire harness configuration as presented by the invention.

FIG. 2B is a schematic illustration of a single wire image and assembly instructions as presented by one embodiment of the invention.

FIG. 3 is one embodiment of an assembly table.

FIG. 4 is one embodiment of a software control program.

FIG. 5 is a second embodiment of a software control program.

FIG. 6 is view of the assembly table being used to construct a wire harness.

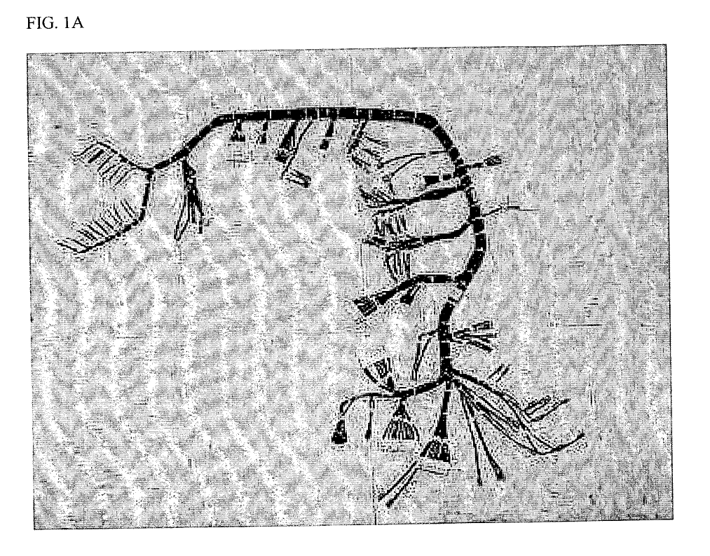

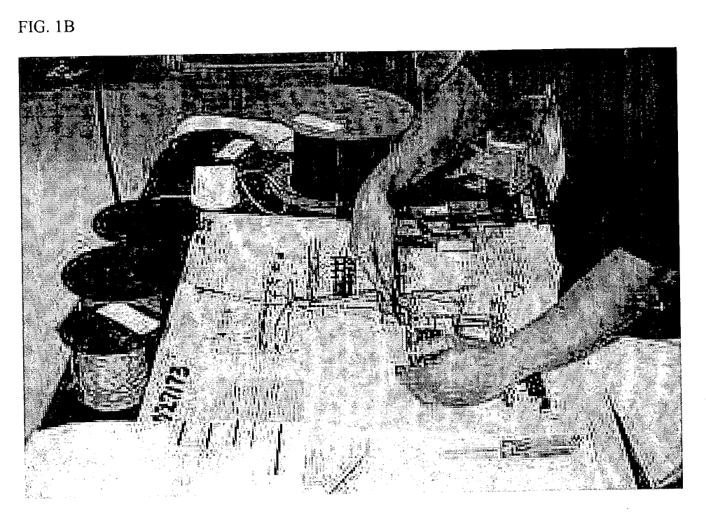

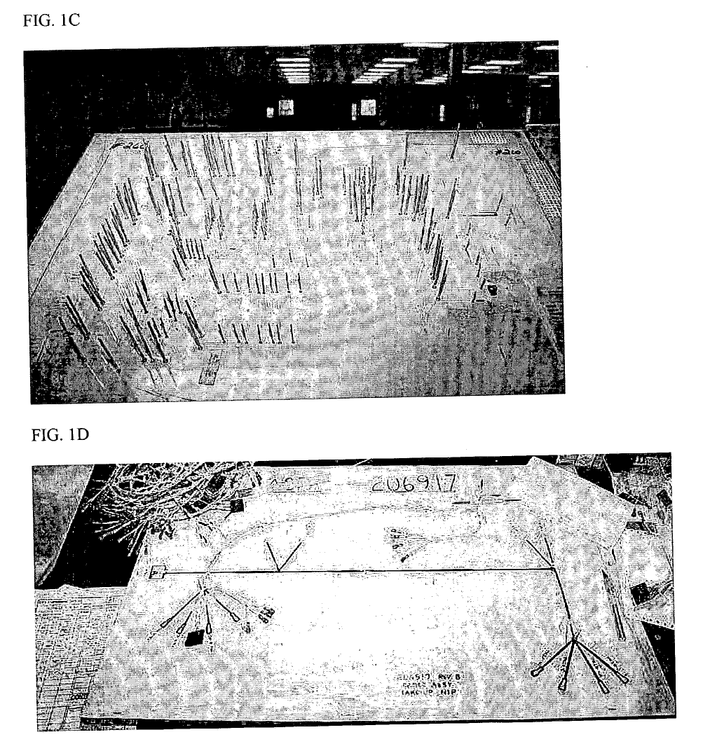

### DETAILED DESCRIPTION OF THE INVENTION

This is an apparatus and method for electronically guiding the manufacturing process of wire harnesses. It is an object of the present invention to provide a wire harness manufacturing system that allows any person with no knowledge or experience of the wire harness manufacturing process to carry out detailed and complicated production of wire harnesses effectively. The invention is directed to both an apparatus and method for electronically sequencing and guiding the assembly of complex wire harnesses with multiple wires, plug connectors and terminations. Several unique structural components function in harmony to provide a manufacturing cell capable of achieving guided wire harness assembly.

More specifically, an object of the present invention is to provide a wire harness manufacturing system that can (1) provide reductions in the design to build time for unique wire harness designs, (2) reduce costly re-work due to errors in assembly, (3) improve the coordination of a plurality of wire harness assembly related tools and machines, (4) reduce facility costs associated with the creation and storage of traditional form boards, (5) serve as a training tool for new assemblers or designs, (6) improve and automate the work instructing process from paper to electronic format, and (7) reduce costs and time associated with design changes that occur during the production cycle.

In order to attain the above object, there is submitted an apparatus and method for electronically sequencing and guiding wire path and wire connection information during the manufacturing process of wire harnesses whereby the user of the system is provided and guided by assembly instructions from a harness intelligent software program that processes and synchronizes essential information required throughout all stages of production: job costing, engineering, pre-production, floor instruction creation, testing and shop floor control.

In one embodiment of the current invention, the user of the apparatus and method of assembly, collectively known as the “system”, receives instructions from a software program and assembles a wire harness using a wire harness assembly table operably connected to said software program. The assembly table hereafter being a workstation, as commonly known in the industry, comprised of a display device, translucent work surface, assembly pins or pegs, attachments and input/output interfaces. The workstation includes, and can be defined in the broadest sense as, any structure that can support and facilitate the production of wire harnesses. Specifically included are tables, easels or workstations designed for wire harness fabrication. It is envisioned that the assembly table would have the ability to adjust the orientation of the translucent work surface to the user of the system on all axes.

As used herein, a “display device” includes any device being capable of visually displaying text and images in a means and fashion understandable to the user of the system. Specifically included are LED units, LCD units, Hologram units, CRT's and computers of all configurations. It is envisioned that the display device would be able to present the text and images in multiple sizes, formats, colors and languages. It is further envisioned that the display device could be comprised of a plurality of those devices specifically identified above.

The “translucent work surface” is hereafter defined as a layer of material (e.g., a composite material) that retains the visual clarity of the images and text being presented by said display device and also provides the basis for assembly of the wire harness. The translucent work surface would vary in thickness depending on the visual clarity desired and the tensile strength requirements for the wire harness to be assembled. It is envisioned that the translucent work surface would be machined or modified to facilitate the insertion and removal of assembly pins that the wires of the wire harness will be placed on during assembly. Specifically included in this definition are polycarbonates such as Lexan™ and Plexi-Glas™. It is further envisioned that the translucent work surface would be treated with a scratchproof film that would assist in maintaining the physical integrity of the attributes defined above.

As used herein, “assembly pins” are defined in the broadest sense to include any suitable structure capable of being attached to and removed from the translucent work surface. The assembly pins would further be defined as being comprised of a plurality of lengths, diameters and materials necessary to support the wire harness being constructed. It is envisioned in the current embodiment being described that the assembly pins are attached via a process that allows insertion and removal without impairing the physical attributes of the translucent protective covering material used. It is further envisioned that the assembly pins would contain a locking mechanism that would temporarily affix the assembly peg to the translucent work surface. One example of this process would be the use of a grid like series of holes machined into the translucent work surface and the use of quick-release spring loaded pins. As used herein, a “pin” is any substantially rigid object capable of contacting (e.g., being inserted into) the translucent work surface of the invention. Further examples include detent ring pins, positive lock pins and detent clevis pins.

The “attachments” are hereafter defined in the broadest sense as tools, devices or structures that assist in the assembly process of wire harnesses. Specifically included are electrical and pneumatic supplies, part bins, cup holders, lighting and receptacles, e.g., testing receptacles, including continuity, pin-to-pin and short testing receptacles.

The “input/output interfaces” are hereafter defined in the broadest sense to include any device or software program which exchanges data with said software program or display device. Specific examples include testing equipment, computer-aided-design programs (CAD), graphical software packages, cutting, terminating, sleeving, marking and printers.

In the current embodiment of the invention, the user of the system assembles a wire harness on an assembly table operably connected to said software control program. Said software control program possessing the functionality to create a new wire harness design or retrieve from memory a previously designed wire harness. The wire harness “design” herein defined as the wire material, wire path, connector, shielding, sleeving and specific assembly instructions necessary to build a wire harness. The specific assembly instructions may include instructions such as “pull test”, “wrap with tape”, “be careful on insertion” or “orient with point up”. The software control program sequences and sends the design information for each wire harness assembly, and more specifically each wire, to the display device.

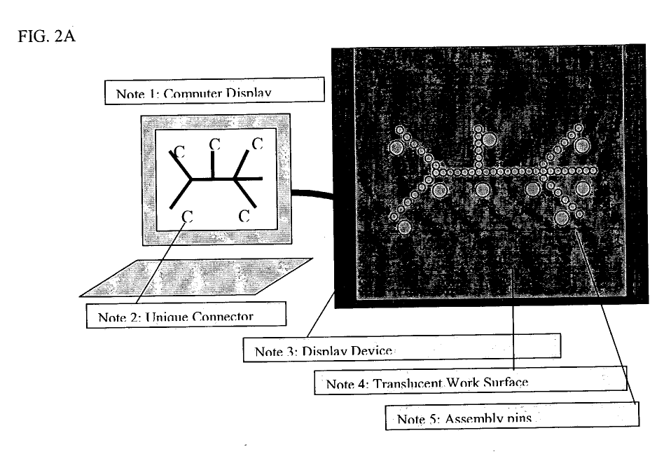

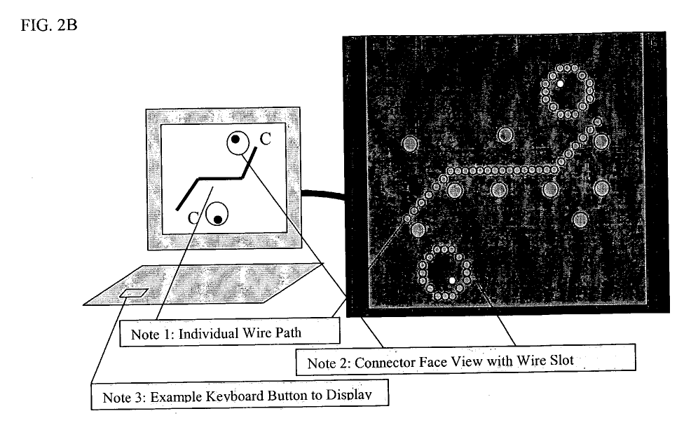

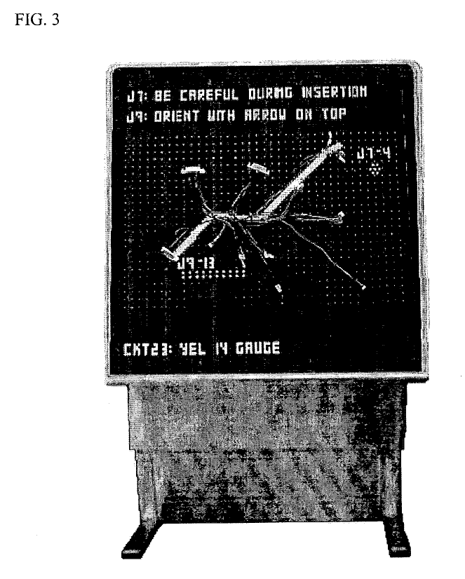

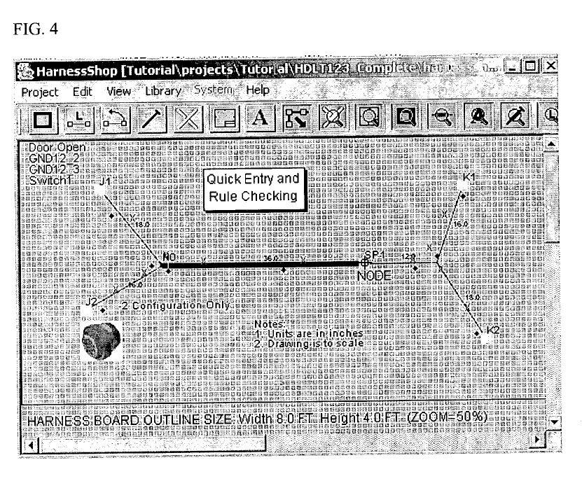

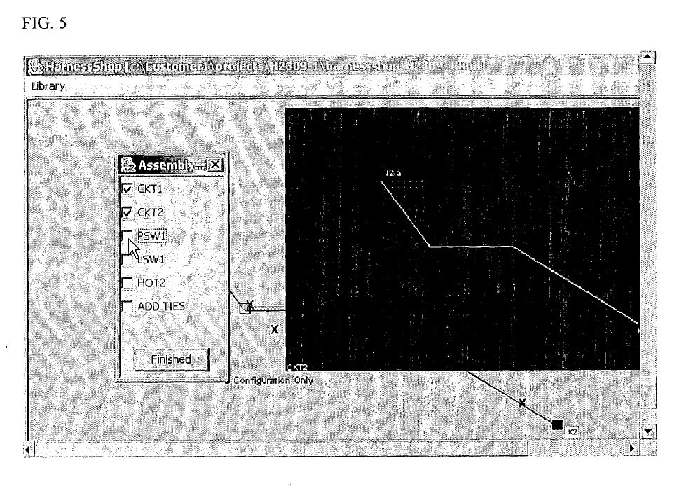

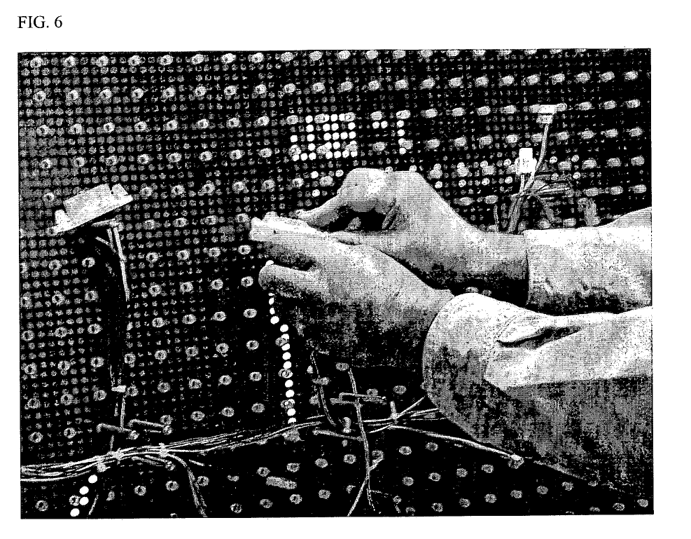

The process entails a user instructing the software to simultaneously display the selected design information on the computer screen and on the display device. FIGS. 4 and 5 provide embodiments of the current invention. The wire path image of the design information displayed by the electronic display machine is the scale of the wire harness to be assembled. FIG. 2A shows a schematic drawing of the full wire harness drawing. This contains all wire paths indicated by Note 1 of FIG. 2A and unique reference designations to the connectors indicated by Note 2 of FIG. 2A. The user then selects a function in said control software which guides the user through the process of creating the unique assembly board for the current wire harness design via assembly peg location prompts which indicate the location for all necessary assembly pins to support the current design in the translucent work surface. Once the unique assembly board has been created, the user is instructed, on a step-by-step basis, on the assembly of the wire harness through the placement of each wire in the life size path displayed by the display device. A schematic example of path and connection information is shown in FIG. 2B. Note 1 of FIG. 2B indicates the path of the wire to be placed, and Note 2 indicates the face views of the connectors where the end points of the wire are to be inserted. The display device also provides additional assembly instructions for each wire such as a face view of the connector that each wire end point is connected to, the location or slot each wire will be inserted into the connector and any other assembly instructions that need to be communicated to the assembler. FIG. 6 is a view of a user assembling a wire harness with the system. The significance of this process is that the user of the system who is assembling the wire harness did not have to consult a chart or separate text document in order to understand where to place and form the wire, and also which connector and connector slot to insert the wire into. The user dictates the pace at which the next assembly images and instructions replace the current assembly images and instructions through voice or device actuated means. Said means include a microphone, keyboard, mouse or similar device. These steps are repeated until a wire assembly has been completed and the user is instructed by said control software on final tie and testing instructions and the wire harness assembly is removed from the assembly table. The assembly table is then available for future production of the same harness design or a quick conversion to a new design as dictated by the control software.

While an embodiment has been shown and described, those skilled in the art will recognize alterations, modifications, and variations that might be made to these embodiments without departing from the inventive concept. Changing the sequence or composition of peripheral attachments does not change or depart from the concept of the system. Therefore, the claims should be interpreted liberally to protect the described embodiments and their reasonable equivalents. The description and drawings are meant to illustrate the invention and are meant to limit the invention only insofar as limitations are necessary in view of the pertinent prior art.

We claim:

1. An apparatus for guiding, controlling and monitoring assembly of a wire harness, comprising:
a display device operably linked to an assembly table.

2. The apparatus of claim 1, wherein said display device is capable of displaying text and images generated by a software program.

3. The apparatus of claim 1, further comprising one or more input/output interfaces.

4. The apparatus of claim 1, wherein said display device is a computer.

5. A configurable wire harness assembly table for the production of a wire harness comprising:
a display device, said device being capable of presenting text and images through receiving information from a computer in order to display wire path and connection information for each individual wire in a wire harness;
a translucent work surface; and
one or more removable assembly pins.

6. The wire harness assembly table of claim 5, wherein said translucent work surface comprises a plurality of holes, said holes being capable of receiving removable assembly pins.

7. The wire harness assembly table of claim 5, wherein the assembly table is adjustable along one or more axes.

8. The wire harness assembly table as described in claim 5, wherein said table further comprises one or more adapter means, said means capable of operably connecting two or more wire harness assembly tables.

9. The wire harness assembly table as described in claim 5, further comprising one or more receptacles.

10. The wire harness assembly table of claim 5, wherein said display device is selected from the group consisting of an LED unit, a OLED unit, a LCD unit, a hologram, a CRT and a computer.

11. The wire harness assembly table of claim 5, wherein said translucent assembly surface has been treated with a scratch-proofing compound.

12. The wire harness assembly table as described in claim 5, wherein said translucent assembly surface is a composite material.

13. A wire harness assembly table as described in claim 5, wherein said software is capable of receiving instructions via voice commands, wired controls or wireless controls.

14. A configurable wire harness assembly table for the production of a wire harness comprising:
a display device, said device being capable of presenting text and images through receiving information from a computer in order to display wire path and connection information for each individual wire in a wire harness, said device further comprising a translucent work surface; and
one or more removable assembly pins.

15. A method for electronically assembling a wire harness, comprising:
a) displaying a predetermined image on a display device, said display device is capable of generating images from a software program, and wherein said image represents a wire harness design;
b) inserting one or more pins into an assembly table operably connected to said display device, wherein the pin placement is controlled by said software;
c) placing a wire on said assembly table, such that wire placement is controlled by said software;
d) terminating said wire into a cavity of a connector housing, wherein said cavity is controlled by said software;
e) completing assembly instructions specific to said wire, wherein said assembly instructions are controlled by said software;
f) repeating steps c), d) and e) one or more times;
g) affixing one or more tie wraps to groups of said wires, wherein the location of said tie wraps is controlled by said software;
h) testing said wire terminations and wire harness circuits, such that a wire harness is assembled.

16. The method of claim 15, wherein said software accumulates and presents management efficiency statistics.

17. The method of claim 15, wherein said software and said testing provides conflict/error notification.

18. The method of claim 15, wherein said software sizes said wire harness design to said assembly table.

19. The method of claim 15, wherein said testing comprises visual inspection.

20. The method of claim 15, wherein said testing comprises electronic inspection
